(19) United States
(12) Patent Application Publication
(10) Pub. No.: US 2012/0326078 A1
(43) Pub. Date: Dec. 27, 2012

(54) METHOD OF PREPARING CATHODE ACTIVE MATERIAL FOR LITHIUM SECONDARY BATTERIES AND LITHIUM SECONDARY BATTERIES USING THE SAME

(75) Inventors: Kyung Yoon CHUNG, Seoul (KR); Won Bin IM, Busan (KR); Byung Won CHO, Seoul (KR); Won Young CHANG, Seoul (KR); Hyung Sun KIM, Seoul (KR)

(73) Assignee: KOREA INSTITUTE OF SCIENCE AND TECHNOLOGY, Seoul (KR)

(21) Appl. No.: 13/286,572

(22) Filed: Nov. 1, 2011

(30) Foreign Application Priority Data
Jun. 24, 2011 (KR) 10-2011-0061623

(51) Int. Cl. H01M 4/04; B01J 19/08; H01M 4/485; C01D 15/02

(52) U.S. Cl. 252/182.1; 204/157.43

(57) ABSTRACT

Disclosed is a method for preparing a cathode active material represented by Li₂MSiO₄ (M=transition metal) for a lithium secondary battery using microwaves, including: 1) dispersing a silicon compound in a solvent; 2) mixing a lithium salt and a transition metal salt in the resulting dispersion and then adding a chelating agent to form complex ions: and 3) treating the mixture with microwaves for gelation. The prepared cathode active material represented by Li₂MSiO₄ (M=transition metal) for a lithium secondary battery has homogeneous composition and superior characteristics. Further, since the preparation process is simple, the production efficiency is good.

### CROSS-REFERENCE TO RELATED APPLICATIONS

This application claims priority under 35 U.S.C. §119 to Korean Patent Application No. 10-2011-0061623, filed on Jun. 24, 2011, in the Korean Intellectual Property Office, the disclosure of which is incorporated herein by reference in its entirety.

### TECHNICAL FIELD

The present disclosure relates to a method for preparing a cathode active material for a lithium secondary battery and a lithium secondary battery prepared thereby. More particularly, the disclosure relates to a method for preparing a cathode active material for a lithium secondary battery uniformly and effectively using microwaves and a lithium secondary battery prepared thereby.

### BACKGROUND

The present disclosure relates to a nano-sized, uniform active material with superior conductivity, electrode capacity and cycle performance synthesized by gelation using microwaves as heat source, a silicate-based electrode using the same, a lithium secondary battery using the same, and a method for preparing the same.

The currently used electrodes for lithium secondary batteries are generally prepared by the solid-phase method. However, since the method involves physical mixing and pulverization, repeated sintering and pulverization are necessary in order to achieve uniform mixing. As a result, the cost and time for manufacturing increase inevitably. In addition, even after the repeated sintering and pulverization processes, the uniformity of particle size or the homogeneity of chemical composition may be undesirable. Since the charging and discharging of the lithium secondary battery are achieved via diffusion of lithium ions, the uniformity of particle size or the homogeneity of composition greatly affects the properties of the electrode and, hence, it is very important to control them. In particular, when a trace amount of heterogeneous elements are doped or surface modification is carried out to improve the characteristics of the cathode active material, the problem of chemical homogeneity becomes severer.

The liquid-phase method was developed to overcome the disadvantages of the solid-phase method. The sol-gel method is the representative example (A. Manthiram et al., Chemistry of Materials, 10, pp. 2895-2909 (1998)). When the transition metal oxide powder is prepared by the sol-gel method involving hydrolysis and condensation, the lithium ions and the transition metal ions are mixed homogeneously by a chelating agent, providing improved homogeneity as compared to the powder prepared by the solid-phase method. Further, since the reactions occur in liquid phase, the particle size is very small. Accordingly, an active material with a large surface area as well as uniform particle size distribution and highly homogenous composition can be attained.

In addition, the manufacturing cost can be saved since the repeated sintering and pulverization processes are unnecessary and the synthesis can be performed at lower temperatures than the solid-phase reactions. Therefore, the sol-gel method is a suitable synthesis when the powder of a cathode active material for a lithium secondary battery is to be synthesized into uniform nano-sized particles or when heterogeneous elements are doped thereto. In the sol-gel method, the gelation time, particle size, uniformity, or the like are dependent on various parameters including pH, pressure, molar concentration, temperature distribution, etc. When the sol-gel method is employed for synthesis, a hot plate or an oven is used to evaporate the solvent and change the sol into a gel. However, with such a method, it is impossible to uniformly heat the entire sample and temperature variation occurs inevitably. This affects the homogeneity of the sample solution and negatively affects the compositional homogeneity, particle size uniformity, etc. of the final product.

### SUMMARY

The present disclosure is directed to providing a method for preparing a silicate-based cathode active material for a lithium secondary battery with improved electrode capacity, cycle performance, output characteristics, etc., ensuring particle size uniformity and compositional homogeneity of the silicate-based cathode active material, allowing a more effective production and reducing synthesis time via a simple process by replacing the currently used heat source.

The present disclosure is also directed to providing an electrode for a lithium secondary battery prepared using thus prepared silicate-based cathode active material, and a lithium secondary battery including the same

In one general aspect, the present disclosure provides a method for preparing a cathode active material represented by Li₂MSiO₄ (M=transition metal) for a lithium secondary battery using microwaves, including: 1) dispersing a silicon compound in a solvent; 2) mixing a lithium salt and a transition metal salt in the resulting dispersion and then adding a chelating agent to form complex ions: and 3) treating the mixture with microwaves for gelation. The transition metal M may be selected from Mn, Fe, Co, Ni, Ti, V, Cr or a mixture thereof.

The silicon compound may be selected from silica, silica tetraacetate, sodium silicate or a mixture thereof. The lithium salt may be selected from lithium acetate, lithium chloride, lithium nitrate, lithium iodide or a mixture thereof, and the transition metal salt may be selected from manganese acetate, manganese chloride, manganese nitrate, manganese sulfate or a mixture thereof. Specifically, a molar ratio of the lithium salt to the transition metal salt may be 2:1.

The chelating agent may be selected from citric acid, adipic acid, ethylene glycol or a mixture thereof.

During the treatment with microwaves, which is an important feature of the present disclosure, the microwaves may have an output of about 1-1300 W and the microwave treatment time may be 1 minute to 6 hours.

In another general aspect, the present disclosure provides a method for manufacturing a lithium secondary battery electrode, including: 1) drying and pulverizing the silicate-based cathode active material represented by Li₂MSiO₄ (M=transition metal) for a lithium secondary battery prepared according to the above-described method; and 2) mixing the pulverized cathode active material with a carbon source and heat treating the resulting mixture. The carbon source may be selected from Denka black, sucrose, Ketjen black and activated carbon, and the heat treatment may be carried out at 600-700° C. for 1-24 hours.

In another general aspect, the present disclosure provides a lithium secondary battery including the silicate-based cathode active material represented by Li₂MSiO₄ (M=transition metal) for a lithium secondary battery prepared according to the above-described method.

Other features and aspects will be apparent from the following detailed description, the drawings, and the claims.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 shows a scanning electron microscopic image of a Li₂MnSiO₄ cathode active material prepared according to the present disclosure;

FIG. 2 shows a scanning electron microscopic image of a carbon-coated Li₂MnSiO₄ cathode active material prepared according to the present disclosure;

FIG. 3 shows a scanning electron microscopic image of a Li₂MnSiO₄ cathode active material prepared according to the existing sol-gel method;

FIG. 4 shows a scanning electron microscopic image of a carbon-coated Li₂MnSiO₄ cathode active material prepared according to the existing sol-gel method;

FIG. 5 shows a charge-discharge test result for an electrode wherein a Li₂MnSiO₄ cathode active material prepared according to the present disclosure is used;

FIG. 6 shows a charge-discharge test result for Li₂MnSiO₄ and carbon-coated Li₂MnSiO₄ electrodes prepared according to the present disclosure; and

FIG. 7 shows a charge-discharge test result for Li₂MnSiO₄ and carbon-coated Li₂MnSiO₄ electrodes prepared according to the existing sol-gel method.

### DETAILED DESCRIPTION OF EMBODIMENTS

The advantages, features and aspects of the present disclosure will become apparent from the following description of the embodiments with reference to the accompanying drawings, which is set forth hereinafter. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. The terminology used herein is for the purpose of describing particular embodiments only and is not intended to be limiting of the example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

The present disclosure provides a method for preparing a cathode active material for a lithium secondary battery. Since a cathode active material synthesized by the solid-phase method has a large particle size, a nano-sized active material is synthesized using the sol-gel method. And, gelation time is reduced temperature is controlled more uniformly by using microwaves as heat source. Thus, an active material with improved uniformity and homogeneity and thus improved electrochemical characteristics can be prepared.

First, a silicate-based cathode active material for a lithium secondary battery is synthesized by a sol-gel process using microwaves as heat source for gelation. In the sol-gel process, the precursors, i.e. a lithium salt, a transition metal salt and a silicon compound are dissolved or suspended in a solvent, and a chelating agent is added to form complex ions of the transition metal. Then, the solvent is slowly removed from the solution, such that a sol is formed as a result of interaction between the ions in the solution. When the reaction proceeds further, a precursor gel with the solvent is formed. This precursor is heat treated to obtain the cathode active material.

Thus synthesized gel maintains uniformity in the molecular level well in liquid state as compared to one prepared by the solid-phase method. As a result, since the diffusion distance of metal ions decreases during the following heat treatment, the heat treatment can be carried out at lower temperature in short time when compared with other methods. In addition, the nonuniform mixing problem of the existing solid-phase methods, particularly in the mixing of trace amounts for doping, can be easily solved by employing the sol-gel process.

However, in the sol-gel method, the gelation time, particle size, uniformity, or the like are dependent on various parameters including pH, pressure, molar concentration, temperature distribution, etc. When the sol-gel method is employed for synthesis, a hot plate or an oven is used to evaporate the solvent and change the sol into gel. However, with such a method, it is impossible to uniformly heat the entire sample and temperature variation occurs inevitably. This affects the homogeneity of the sample solution and negatively affects the compositional homogeneity, particle size uniformity, etc. of the final product.

Since the present disclosure employs a sol-gel method using microwaves as heat source, a sol. The precursors, i.e. a lithium salt, a transition metal salt and a silicon compound are dissolved or suspended in a solvent, and a chelating agent is added to form complex ions of the transition metal. Then, the mixture is treated with microwaves while controlling output, time, temperature and pressure for gelation. Thus formed gel is dried and then prepared into the silicate-based electrode following pulverization and heat treatment for use in the manufacturing of the electrode and the battery.

Specifically, a method for preparing a silicate-based cathode active material represented by Li₂MSiO₄ (M=transition metal) for a lithium secondary battery using microwaves according to the present disclosure comprises: 1) dispersing a silicon compound in a solvent; 2) mixing a lithium salt and a transition metal salt in the resulting dispersion and then adding a chelating agent to form complex ions: and 3) treating the mixture with microwaves for gelation.

In an embodiment of the present disclosure, the transition metal M of the silicate cathode active material Li₂MSiO₄ may be selected from Mn, Fe, Co, Ni, Ti, V, Cr or a mixture thereof.

In another embodiment of the present disclosure, the silicon compound may be selected from silica, silica tetraacetate, sodium silicate or a mixture thereof. Specifically, silica may be used among them.

In another embodiment of the present disclosure, the lithium salt may be selected from lithium acetate, lithium chloride, lithium nitrate, lithium iodide or a mixture thereof, and the transition metal salt may be selected from manganese acetate, manganese chloride, manganese nitrate, manganese sulfate or a mixture thereof. Specifically, a molar ratio of the lithium salt to the transition metal salt may be 2:1, so that 2 mol of lithium may be intercalated and/or deintercalated per 1 mol of the transition metal to give high specific capacity.

In another embodiment of the present disclosure, the chelating agent may be selected from citric acid, adipic acid, ethylene glycol or a mixture thereof.

In another embodiment of the present disclosure, the microwaves used in the microwave treatment may have an output of 1-1300 W, and the microwave treatment time may be 1 minute to 6 hours. The microwave treatment is a technique of applying high energy in short time for synthesis. The state of the produced material may change greatly depending on the magnitude of the energy and the treatment time. To apply the high energy for more than 6 hours is inefficient in terms of economy.

A method for manufacturing a lithium secondary battery electrode according to the present disclosure comprises: drying and pulverizing the silicate-based cathode active material represented by Li₂MSiO₄ (M=transition metal) for a lithium secondary battery prepared by the above-described method; and mixing the pulverized cathode active material with a carbon source and heat treating the resulting mixture.

The carbon source may be selected from Denka black, sucrose, Ketjen black and activated carbon. Specifically, Denka black or sucrose may be used among them. The heat treatment may be carried out at 600-700° C. for 1-24 hours. When manufacturing the cathode active material for a lithium secondary battery, it is important to adequately control the temperature and time of the heat treatment process. It is because the stable phases are different for different temperatures. Also, as the heat treatment time increases, the crystal size, which affects the electrode performance, also increases. A high heat treatment temperature and a long heat treatment time may negatively affect the capacitive property of the electrode by accelerating the oxidation of lithium.

Finally, the present disclosure provides a lithium secondary battery comprising the silicate-based cathode active material represented by Li₂MSiO₄ (M=transition metal) for a lithium secondary battery prepared the above-described method using microwaves.

### EXAMPLES

The examples and experiments will now be described. The following examples and experiments are for illustrative purposes only and not intended to limit the scope of this disclosure.

### Example 1

Silica (2.25 g) was dispersed in distilled water (340 mL) for 1 hour. To the resulting solution, lithium acetate and manganese acetate, each dissolved in 100 mL of distilled water, were added, such that the molar ratio of the metal ions was 2:1. Then, a mixture of citric acid and ethylene glycol was added as a chelating agent to form transition metal complex ions.

After mixing for 12 hours, the solution was treated with microwaves with an output of 1-1300 W for 1 minute to 6 hours for gelation. Then, moisture was evaporated from the resulting gel in an oven at 80° C. After the drying, the gel was pulverized transferred to an alumina crucible and heat treated for at 600-700° C. 12-24 hours under argon/hydrogen mixture gas atmosphere. The resultant was pulverized to obtain a Li₂MnSiO₄ cathode active material. A scanning electron microscopic image of the cathode active material is shown in FIG. 1.

Subsequently, the Li₂MnSiO₄ cathode active material (3 g) was mixed with Denka black (0.36 g) and PVDF (0.25 g). After adding NMP, when an appropriate viscosity was obtained, the mixture was cast on an aluminum foil, dried, and then rolling pressed to manufacture a Li₂MnSiO₄ electrode.

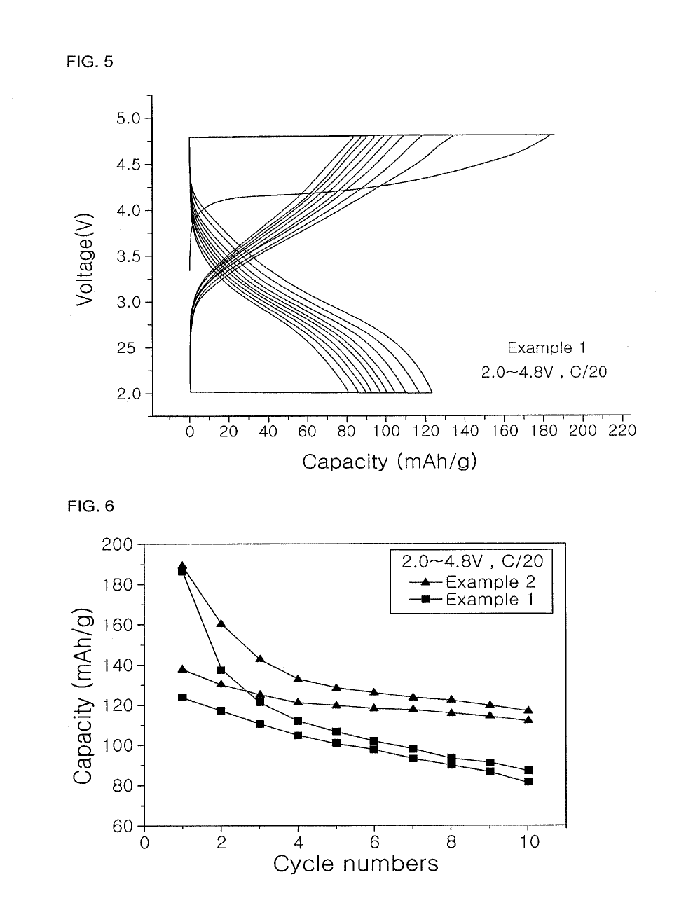

The Li₂MnSiO₄ electrode, a PP separator and a lithium counter electrode were used to configure a half cell of a lithium secondary battery. After injecting a solution of 1 M LiPF₆ dissolved in EC:DMC:DEC, charge-discharge behavior and cycle performance were investigated in the voltage range of 2.0-4.8 V at a current density of C/20 by the constant current charge-discharge method. The result is shown in FIG. 5 and FIG. 6.

### Example 2

Silica (2.25 g) was dispersed in distilled water (340 mL) for 1 hour. To the resulting solution, lithium acetate and manganese acetate, each dissolved in 100 mL of distilled water, were added, such that the molar ratio of the metal ions was 2:1. Then, a mixture of citric acid and ethylene glycol was added as a chelating agent to form transition metal complex ions.

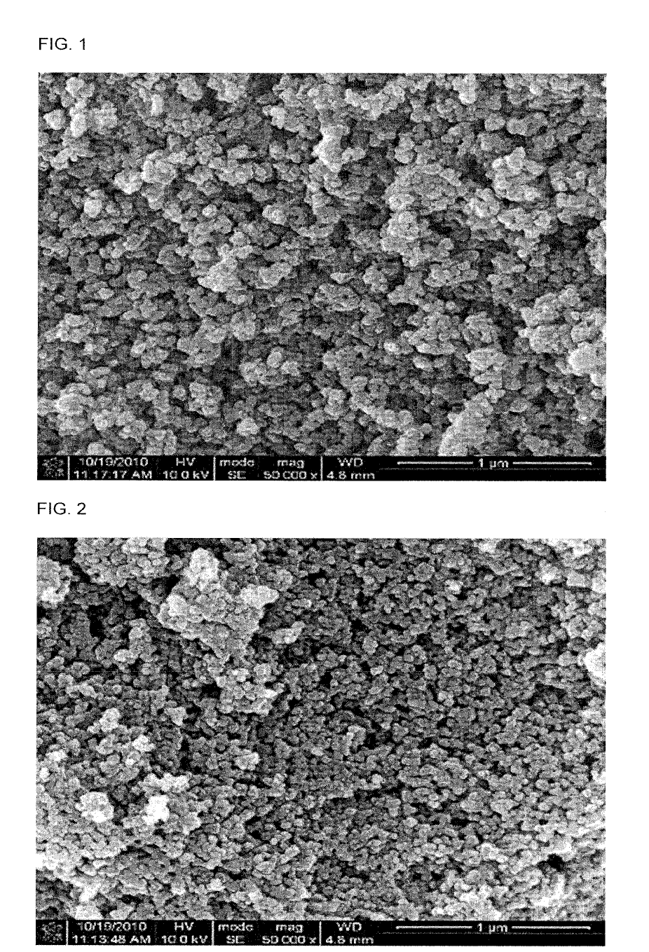

After mixing for 12 hours, the solution was treated with microwaves with an output of 1-1300 W for 1 minute to 6 hours for gelation. Then, moisture was evaporated from the resulting gel in an oven at 80° C. After the drying, the gel was pulverized, mixed with 5 wt % of sucrose based on the weight of the active material, transferred to an alumina crucible and heat treated for at 600-700° C. 12-24 hours under argon/hydrogen mixture gas atmosphere. The resultant was pulverized to obtain a Li₂MnSiO₄ cathode active material. A scanning electron microscopic image of the cathode active material is shown in FIG. 2. Then, the charge-discharge behavior was investigated under the same condition as in Example 1. The result is shown in FIG. 6.

### Example 3

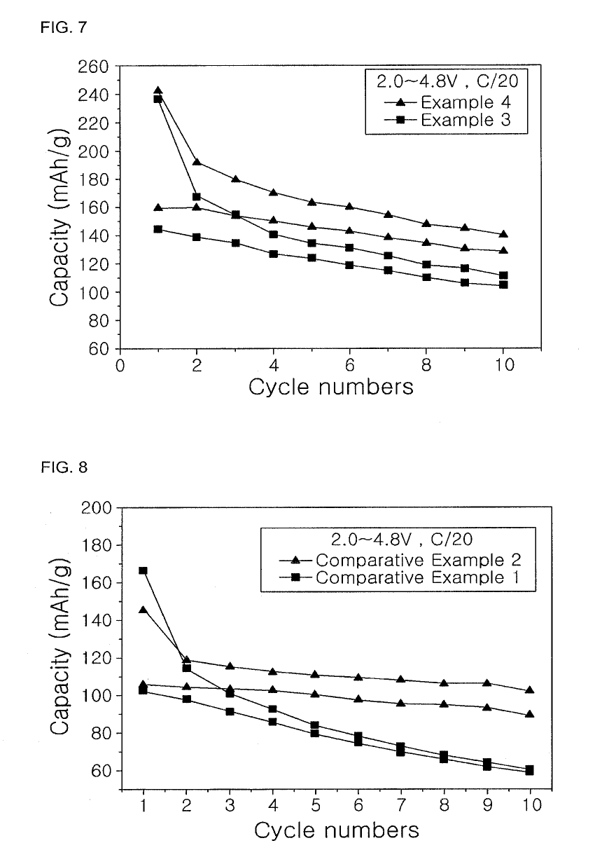

A Li₂MnSiO₄ half cell was manufactured under the same condition as in Example 1 and the charge-discharge behavior was investigated at elevated temperature of 50° C. The result is shown in FIG. 7.

### Example 4

A Li₂MnSiO₄ half cell was manufactured under the same condition as in Example 2 and the charge-discharge behavior was investigated at elevated temperature of 50° C. The result is shown in FIG. 7.

### Comparative Example 1

Silica (2.25 g) was dispersed in distilled water (340 mL) for 1 hour according to the existing sol-gel method. To the resulting solution, lithium acetate and manganese acetate, each dissolved in 100 mL of distilled water, were added, such that the molar ratio of the metal ions was 2:1. Then, a mixture of citric acid and ethylene glycol was added as a chelating agent to form transition metal complex ions.

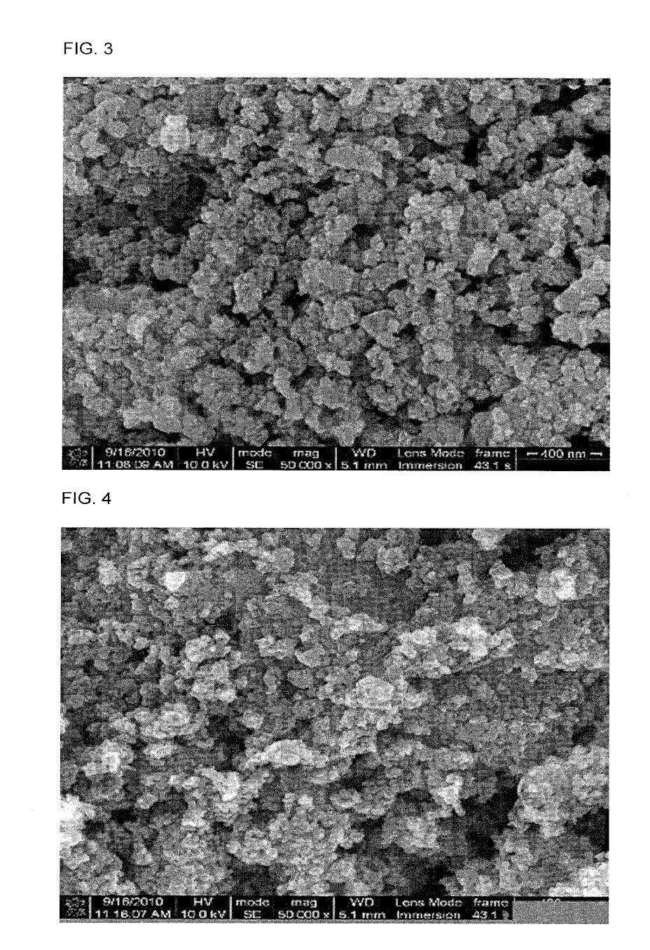

After mixing for 12 hours, the solution was kept in an oven at 80° C. to evaporate moisture. As the moisture was evaporated, the solution turned into a gel. The gel was dried and pulverized in the same manner as in Example 1. A scanning electron microscopic image of the resulting cathode active material is shown in FIG. 3. Then, the charge-discharge behavior was investigated under the same condition as in Example 1. The result is shown in FIG. 8.

### Comparative Example 2

Silica (2.25 g) was dispersed in distilled water (340 mL) for 1 hour according to the existing sol-gel method. To the resulting solution, lithium acetate and manganese acetate, each dissolved in 100 mL of distilled water, were added, such that the molar ratio of the metal ions was 2:1.

After mixing for 12 hours, the solution was kept in an oven at 80° C. to evaporate moisture. As the moisture was evaporated, the solution turned into a gel. The gel was dried, pulverized, mixed with 5 wt % of sucrose based on the weight of the active material, transferred to an alumina crucible and heat treated for at 600-700° C. 12-24 hours under argon/hydrogen mixture gas atmosphere. The resultant was pulverized to obtain a Li₂MnSiO₄ cathode active material. A scanning electron microscopic image of the cathode active material is shown in FIG. 4. Then, the charge-discharge behavior was investigated under the same condition as in Example 1. The result is shown in FIG. 8.

As seen from FIGS. 1, 2, 3 and 4, the present disclosure allows the preparation of smaller and more uniform particles as compared to the existing sol-gel method. Also, as seen from FIGS. 6 and 8, the batteries of the present disclosure exhibit better capacitance properties than those prepared using the existing sol-gel method (Comparative Examples 1 and 2). And, as seen from FIG. 7, the batteries of the present disclosure show better capacitance properties and cycle performance at elevated temperature.

When the cathode active material for a lithium secondary battery is synthesized by the sol-gel method according to the present disclosure using microwaves as heat source, the problems of undesirable compositional homogeneity and particle size uniformity of the existing sol-gel method wherein a hot plate or an oven is used to evaporate the solvent, which are caused by nonuniform temperature, can be solved since the temperature can be increased uniformly. Consequently, the electrochemical characteristics of the electrode material including capacity, life cycle, output characteristics, etc. can be improved. Especially, a much better effect can be expected for a silicate-based electrode material such as Li₂MSiO₄ (M=transition metal) of the present disclosure, since it has very low electrical conductivity, ion conductivity and diffusion coefficient.

While the present disclosure has been described with respect to the specific embodiments, it will be apparent to those skilled in the art that various changes and modifications may be made without departing from the spirit and scope of the disclosure as defined in the following claims.

What is claimed is:

1. A method for preparing a cathode active material represented by Li₂MSiO₄ (M=transition metal) for a lithium secondary battery using microwaves, comprising:
dispersing a silicon compound in a solvent;
mixing a lithium salt and a transition metal salt in the resulting dispersion and then adding a chelating agent to form complex ions: and
treating the mixture with microwaves for gelation.

2. The method for preparing a cathode active material for a lithium secondary battery according to claim 1, wherein the transition metal M is selected from Mn, Fe, Co, Ni, Ti, V, Cr or a mixture thereof.

3. The method for preparing a cathode active material for a lithium secondary battery according to claim 1, wherein the silicon compound is selected from silica, silica tetraacetate, sodium silicate or a mixture thereof.

4. The method for preparing a cathode active material for a lithium secondary battery according to claim 1, wherein the lithium salt compound is selected from lithium acetate, lithium chloride, lithium nitrate, lithium iodide or a mixture thereof.

5. The method for preparing a cathode active material for a lithium secondary battery according to claim 1, wherein the transition metal salt is selected from manganese acetate, manganese chloride, manganese nitrate, manganese sulfate or a mixture thereof.

6. The method for preparing a cathode active material for a lithium secondary battery according to claim 1, wherein a molar ratio of the lithium salt to the transition metal salt is 2:1.

7. The method for preparing a cathode active material for a lithium secondary battery according to claim 1, wherein the chelating agent is selected from citric acid, adipic acid, ethylene glycol or a mixture thereof.

8. The method for preparing a cathode active material for a lithium secondary battery according to claim 1, wherein the microwaves have an output of 1-1300 W.

9. The method for preparing a cathode active material for a lithium secondary battery according to claim 1, wherein the treatment with microwaves is carried out for 1 minute to 6 hours.

10. A method for manufacturing a lithium secondary battery electrode, comprising:
drying and pulverizing the silicate-based cathode active material represented by Li₂MSiO₄ (M=transition metal) for a lithium secondary battery prepared according to claim 1; and
mixing the pulverized cathode active material with a carbon source and heat treating the resulting mixture.

11. The method for preparing a cathode active material for a lithium secondary battery according to claim 10, wherein the carbon source is selected from Denka black, sucrose, Ketjen black and activated carbon.

12. The method for preparing a cathode active material for a lithium secondary battery according to claim 10, wherein the heat treatment is carried out at 600-700° C. for 1 hour-24 hours.
